(19) United States
(12) Patent Application Publication
(10) Pub. No.: US 2025/0316049 A1
(43) Pub. Date: Oct. 9, 2025

(54) METHOD FOR DETECTING FRAMES

(71) Applicant: Jabil Inc., St. Petersburg, FL (US)

(72) Inventors: Jin Ho Lim, Butterworth (MY); Jyh Woei Ch'ng, Bayan Lepas (MY); Wai Keat Tan, Kulim Kedah (MY); Wei Lun Ng, Simpang Ampat (MY); Wang Yan Ling, Bayan Lepas (MY); Teik Jin Lee, Sungai Nibong (MY)

(73) Assignee: Jabil Inc., St. Petersburg, FL (US)

(21) Appl. No.: 19/009,284

(22) Filed: Jan. 3, 2025

(30) Foreign Application Priority Data
Apr. 8, 2024 (CN) 202410417295.6

(51) Int. Cl. G06V 10/25; G06V 10/764; G06V 20/52; G06V 30/146; G06V 40/16

(52) U.S. Cl. CPC G06V 10/25; G06V 10/764; G06V 20/52; G06V 30/147; G06V 40/172; G06V 2201/02

(57) ABSTRACT

A method for detecting frames is implemented using a system that is connected to a display apparatus and an external management port. The system includes a video capturing device and a computing device. The method includes: obtaining, by the video capturing device, a video feed from the display apparatus, and transmitting the video feed to the computing device; in response to receipt of the video feed, processing, by the computing device, the video feed to obtain a displaying frame; processing, by the computing device, the displaying frame to obtain a region of interest (ROI) within the displaying frame; obtaining, by the computing device, an identification result associated with a content included in the ROI; and transmitting, by the computing device, the identification result to the external management port.

### CROSS-REFERENCE TO RELATED APPLICATION

This application claims priority to Chinese Invention patent application Ser. No. 20/241,0417295.6, filed on Apr. 8, 2024, the entire disclosure of which is incorporated by reference herein.

### FIELD

The disclosure relates to a method for image capture, and particularly to a method for implementing screen capture on an external display for detecting frames.

### BACKGROUND

As the technology in the field of image display advances, using a display device to present information in the form of images, texts and videos, etc., has become a common technique. In another application, numerous display devices have been commonly employed for monitoring various information.

In one application, factories may employ a computer device to detect an operation status of at least one machine, and control a display apparatus such as a screen to display the operation status of the at least one machine. It is noted that the operation result is displayed on the display apparatus for inspection by personnel to determine whether the operation status of the at least one machine is normal.

### SUMMARY

Therefore, an object of the disclosure is to provide a method that is configured to automatically implement frame detecting, to obtain an identification result from a displaying frame, and to transmit the identification result to a remote party.

According to one embodiment of the disclosure, the method for detecting frames is implemented using a system that is connected to a display apparatus and an external management port, the system including a video capturing device and a computing device connected to the video capturing device. The method includes:
a) obtaining, by the video capturing device, a video feed from the display apparatus, and transmitting the video feed to the computing device;
b) in response to receipt of the video feed, processing, by the computing device, the video feed to obtain a displaying frame;
c) processing, by the computing device, the displaying frame to obtain a region of interest (ROI) within the displaying frame;
d) obtaining, by the computing device, an identification result associated with a content included in the ROI; and
e) transmitting, by the computing device, the identification result to the external management port.

Another object of the disclosure is to provide a system for implementing the above-mentioned method.

According to one embodiment of the disclosure, the system for detecting frames is connected to a display apparatus and an external management port. The system includes a video capturing device and a computing device connected to the video capturing device. The video capturing device obtains a video feed from the display apparatus, and transmits the video feed to the computing device. In response to receipt of the video feed, the computing device processes the video feed to obtain a displaying frame, processes the displaying frame to obtain a region of interest (ROI) within the displaying frame, obtains an identification result associated with a content included in the ROI, and transmits the identification result to the management port.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating components of a system for implementing a method for detecting frames according to one embodiment of the disclosure.

FIG. 2 is a flow chart illustrating steps of a method for detecting frames according to one embodiment of the disclosure.

FIG. 3 is a flow chart illustrating sub-steps of step 33 according to one embodiment of the disclosure.

FIG. 4 is a flow chart illustrating sub-steps of steps 34 and 35 according to one embodiment of the disclosure.

FIG. 5 is a flow chart illustrating sub-steps of steps 34 and 35 according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

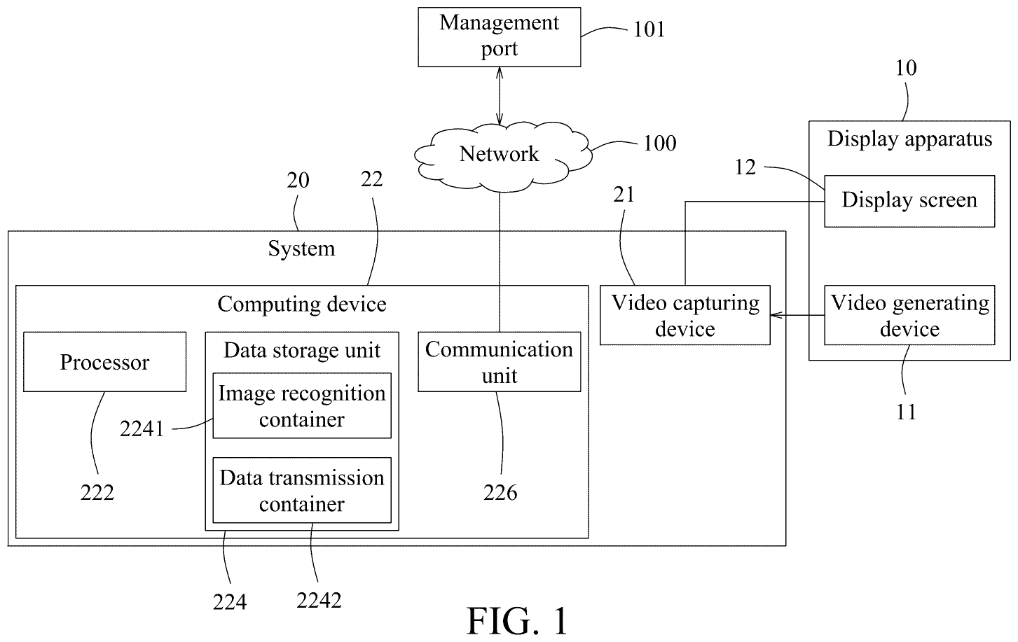

FIG. 1 is a block diagram illustrating components of a system 20 for implementing a method for detecting frames according to one embodiment of the disclosure. In the embodiment of FIG. 1, the system 20 is connected to an external display apparatus (hereinafter display apparatus) 10 and an external management port (hereinafter management port) 101, and includes a video capturing device 21 and a computing device 22 connected to the video capturing device 21. The video capturing device 21 may be embodied using a video capture card, and is connected to the computing device 22 via an interface, such as a camera serial interface (CSI), a universal serial bus (USB), etc. The computing device 22 may be embodied using a single-board computer (SBC), a personal computer, a laptop, a server, etc.

The display apparatus 10 may include a video generating device 11 and a display screen 12. The video generating device 11 may be embodied using a personal computer, a monitoring host device, a server, etc. The video generating device 11 is connected to the video capturing device 21 via, for example, a video graphics array (VGA) connector, a high definition multimedia interface (HDMI) connector, etc., and may include a processor for generating a video feed. The video capturing device 21 is configured to receive the video feed from the video generating device 11, and to transmit the video feed to the computing device 22 and the display screen 12. In some embodiments, the video capturing device 21 is connected to the display screen 12 via another HDMI connector.

The management port 101 may be embodied using a personal computer, a monitoring host device, a server, etc., and is in a wireless communication with the computing device 22 via a network 100 (e.g., the Internet).

In use, the external display apparatus 10 may be employed to implement different functions to display information on the display screen 12. In some examples, the display screen 12 may display information related to a real time operation status and parameters of a specific machine (not shown in the drawings). Typically, the real time operation status is displayed for inspection and interpretation by a personnel.

The computing device 22 includes a processor 222, a data storage unit 224, and a communication unit 226.

The processor 222 may be embodied using one or more of a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application-specific integrated circuit (ASIC), a radio-frequency integrated circuit (RFIC), etc.

The communication unit 226 is connected to the processor 222, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) of, the fourth generation (4G) of or the fifth generation (5G) of wireless mobile telecommunications technology, or the like. The communication unit 226 enables the communication with the management port 101.

The data storage unit 224 is connected to the processor 222, and may be embodied using, for example, one or more of random access memory (RAM), read only memory (ROM), programmable ROM (PROM), firmware, flash memory, etc. In this embodiment, the data storage unit 224 stores a number of containers for enabling implementation of specific operations on various platforms. Specifically, the containers include an image recognition container 2241 for enabling an image recognition functionality, and a data transmission container 2242 for enabling a data transmission functionality. In use, the processor 222 is configured to execute the containers for causing the computing device 22 to implement the operations as described below. The use of containers ensures that the employment of the system 20 may be easily done on different kinds of hardware and operating systems (OSs). In some embodiments, the data storage unit 224 may store a software application including instructions that, when executed by the processor 222, cause the processor 222 to implement the operations as described below.

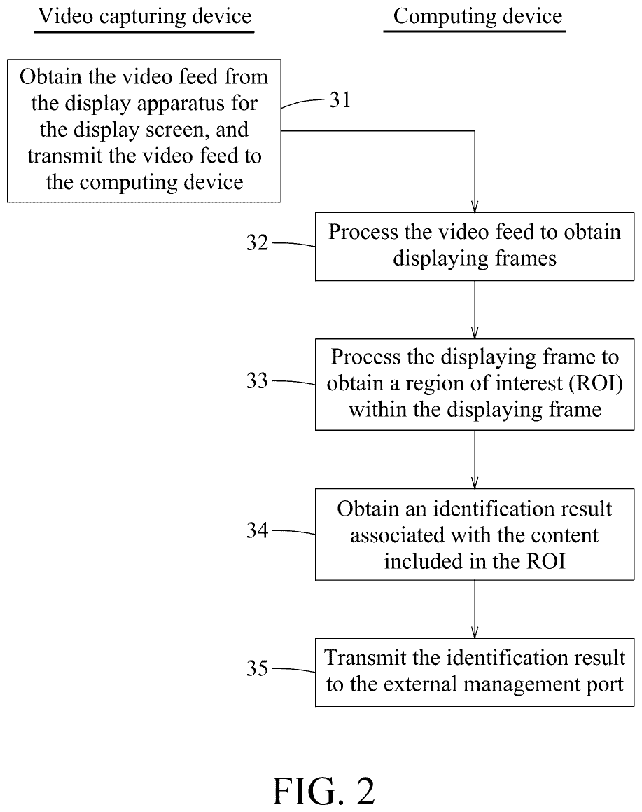

FIG. 2 is a flow chart illustrating steps of a method for detecting frames according to one embodiment of the disclosure. In this embodiment, the method is implemented using the system 20 as shown in FIG. 1.

In step 31, the computing device 22 activates the video capturing device 21, which is configured to obtain the video feed from the display apparatus 10, and to transmit the video feed to the computing device 22. It is noted that the video feed from the display apparatus 10 may be also transmitted to the display screen 12.

In response to receipt of the video feed, in step 32, the computing device 22 processes the video feed to obtain displaying frames. For the sake of illustration, in the following process, only one frame is processed. In some embodiments, the computing device 22 may execute a decoding operation using a computer vision software library that provides programming functions, such as Open Source Computer Vision Library (OpenCV).

In step 33, the computing device 22 processes the displaying frame to obtain a region of interest (ROI) within the displaying frame. In some embodiments, the computing device 22 may execute one of the containers stored in the data storage unit 224 (e.g., the image recognition container 2241) for implementing the operations of step 33.

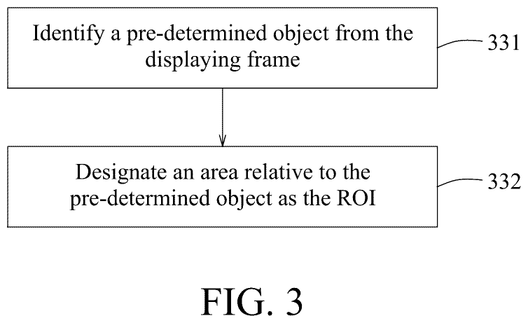

FIG. 3 is a flow chart illustrating sub-steps of step 33 according to one embodiment of the disclosure.

In sub-step 331, the computing device 22 executes the image recognition container 2241 to identify a pre-determined object from the displaying frame. In some embodiments, the pre-determined object may be an object that is constantly presented in the displaying frame, such as a logo, an icon, a graphic, a text box, etc. in different applications, but is not limited to such.

Then, in sub-step 332, the computing device 22 executes the image recognition container 2241 to designate an area relative to the pre-determined object as the ROI. For example, the area may be designated as a rectangular area that encloses the pre-determined object. In other embodiments, the ROI may be defined to contain a fixed area of the displaying frame.

In step 34, the computing device 22 executes the image recognition container 2241 to obtain an identification result associated with the content included in the ROI.

In different embodiments, the identification result may include different contents, such as the operation status and the parameters of the specific machine. In use, the computing device 22 may execute a character reading tool (e.g., an Optical Character Recognition (OCR) software) to determine whether one or more characters are present in the ROI, and, if so, a string of characters is to be obtained as the identification result.

It is noted that in some embodiments, the video feed may include contents for a plurality of successive displaying frames, and the operation of step 34 may involve processing a plurality of displaying frames to obtain the identification result.

Then, in step 35, the computing device 22 executes the data transmission container 2242 to transmit the identification result to the management port 101.

In some embodiments, the transmission may be done using a Message Queuing Telemetry Transport (MQTT) protocol, which is a message queuing service.

In one implementation, the display screen 12 may be configured to display information related to the real time operation status and the parameters of the specific machine, and the video feed contains the content of the displaying frame. After the video capturing device 21 obtains the video feed from the external display apparatus 10 and transmits the video feed to the computing device 22, the computing device 22 is configured to obtain the displaying frame and the ROI of the displaying frame, and to obtain an identification result associated with the content included in the ROI. Specifically, the identification result may be obtained by the computing device 22 executing the OCR software to extract one or more character(s) as the identification result, and may be in the form of a character or a string of characters.

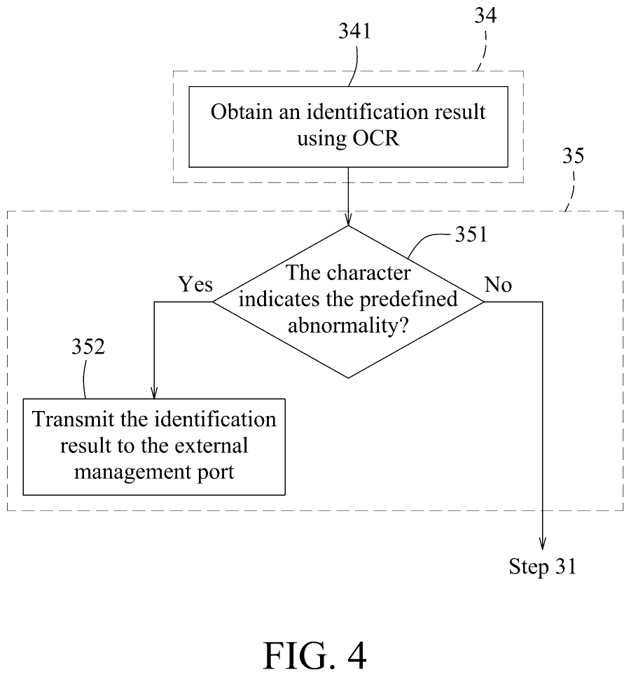

In some embodiments, the method is implemented in specific applications, and therefore steps 34 and 35 may include other mechanisms for determining whether the identification result indicates a predefined abnormality (i.e., whether an abnormality is detected). For example, FIG. 4 is a flow chart illustrating sub-steps of steps 34 and 35 according to one embodiment of the disclosure. In this embodiment, after the identification result is obtained using the OCR software in sub-step 341, in sub-step 351, the computing device 22 executes the image recognition container 2241 to determine whether the identification result, e.g., a character or a string of characters, indicates the predefined abnormality, such as an error message associated with the operation status of the specific machine.

In the case that the determination is negative (i.e., no abnormality is detected), the flow goes back to step 31 for obtaining another displaying frame. Otherwise, in the case that the determination is affirmative, the flow proceeds to sub-step 352, in which the computing device 22 transmits the identification result to the management port 101.

The above configuration is particularly useful in the application where the machine is in operation, and human intervention is not needed unless an abnormality is detected. In such cases, the personnel does not need to be near the display screen 12 all the time, and the identification result is not transmitted to the management port 101 when no abnormality is detected.

In another application, the video generating device 11 may further include a monitoring camera (e.g., placed in front of an entrance of a building), and the video feed may be the video captured by the monitoring camera. In such a case, the ROI may be defined in step 33 to enclose a human face, and the identification result implemented in step 34 may be done by the computing device 22 implementing the object recognition operations (e.g., executing a facial recognition algorithm to perform a facial recognition operation) on the ROI. The identification result may be in the form of an identity of a known person whose facial data is stored in the data storage unit 224 (indicating an employee of an institution, a member of a club, etc.), or an unknown person whose facial data is absent from the data storage unit 224.

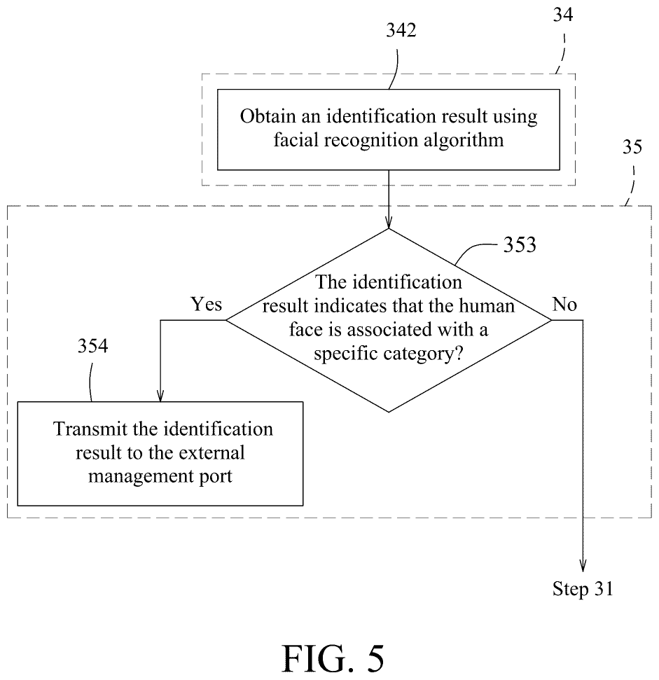

FIG. 5 is a flow chart illustrating sub-steps of steps 34 and 35 according to one embodiment of the disclosure. In this embodiment, after the identification result is obtained using facial recognition algorithm in step 342, in sub-step 353, the computing device 22 executes the image recognition container 2241 to determine whether the identification result indicates that the human face is associated with a specific category (e.g., to determine that the human face belongs to a known person or an unknown person).

In the case that the determination is negative (i.e., the human face of a person entering the building belongs to a known person), the flow goes back to step 31 for obtaining another displaying frame. Otherwise, in the case that the determination is affirmative (i.e., the human face of a person entering the building belongs to an unknown person), the flow proceeds to sub-step 354, in which the computing device 22 transmits the identification result to the management port 101.

The above configuration is particularly useful in the application where numerous people are coming in the building, and human intervention is not needed unless a person without clearance is trying to get in the building. In such cases, the personnel does not need to be near the display screen 12 all the time, and the identification result is not transmitted to the external management port 101 when no abnormality is detected.

To sum up, embodiments of the disclosure provide a method for detecting frames. In the method, the video feed for the display screen 12 is captured by a video capturing device 21, and then is transmitted to a computing device 22 for processing. The computing device 22 obtains a displaying frame and an ROI within the displaying frame. Then, the computing device 22 processes the ROI to obtain an identification result, and may directly transmit the identification result to an external management port 101, or in some cases, may transmit the identification result to the external management port 101 after determining that the transmission is necessary. In such cases, it is unnecessary to deploy a personnel to continuously watch the display screen 12.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for detecting frames, the method being implemented using a system that is connected to a display apparatus and an external management port, the system including a video capturing device and a computing device connected to the video capturing device, the method comprising:
a) obtaining, by the video capturing device, a video feed from the display apparatus, and transmitting the video feed to the computing device;
b) in response to receipt of the video feed, processing, by the computing device, the video feed to obtain a displaying frame;
c) processing, by the computing device, the displaying frame to obtain a region of interest (ROI) within the displaying frame;
d) obtaining, by the computing device, an identification result associated with a content included in the ROI; and
e) transmitting, by the computing device, the identification result to the management port.

2. The method as claimed in claim 1, wherein step d) includes the computing device executing an Optical Character Recognition (OCR) software to extract a character as the identification result.

3. The method as claimed in claim 2, wherein step e) includes:
determining whether the identification result indicates a predefined abnormal condition; and
in a case where the identification result indicates the predefined abnormal condition, transmitting the identification result to the management port.

4. The method as claimed in claim 1, wherein step d) includes the computing device executing a recognition algorithm to perform an object recognition operation on the ROI to obtain a classification result as the identification result.

5. The method as claimed in claim 4, wherein step e) includes:
determining whether the identification result indicates that the classification result is associated with a specific category; and
in a case where the identification result indicates that the classification result is associated with the specific category, transmitting the identification result to the management port.

6. The method as claimed in claim 1, wherein step e) includes transmitting the identification result to the management port using a Message Queuing Telemetry Transport (MQTT) protocol.

7. The method as claimed in claim 1, wherein step c) includes defining the ROI to contain a fixed area of the displaying frame.

8. The method as claimed in claim 1, wherein step c) includes:
identifying a pre-determined object from the displaying frame; and
designating an area relative to the pre-determined object as the ROI.

9. The method as claimed in claim 1, the computing device including an image recognition container for enabling an image recognition functionality, wherein:
step c) includes the computing device executing the image recognition container to obtain the ROI; and
step d) includes the computing device executing the image recognition container to obtain the identification result for the ROI.

10. The method as claimed in claim 1, the computing device including a data transmission container for enabling a data transmission functionality, wherein:
step e) includes the computing device executing the data transmission container to transmit the identification result to the management port.

11. A system for detecting frames, the system being connected to a display apparatus and an external management port, and comprising a video capturing device and a computing device connected to the video capturing device, wherein:
the video capturing device obtains a video feed from the display apparatus, and transmits the video feed to the computing device;
in response to receipt of the video feed, the computing device processes the video feed to obtain a displaying frame, processes the displaying frame to obtain a region of interest (ROI) within the displaying frame, obtains an identification result associated with a content included in the ROI, and transmits the identification result to the management port.

12. The system as claimed in claim 11, wherein the computing device executes an Optical Character Recognition (OCR) software to extract a character as the identification result.

13. The system as claimed in claim 12, wherein the computing device determines whether the identification result indicates a predefined abnormal condition, and in a case where the identification result indicates the predefined abnormal condition, transmits the identification result to the management port.

14. The system as claimed in claim 11, wherein the computing device executes a recognition algorithm to perform an object recognition operation on the ROI to obtain a classification result as the identification result.

15. The system as claimed in claim 14, wherein the computing device determines whether the identification result indicates that the classification result is associated with a specific category, and in a case where the identification result indicates that the classification result is associated with the specific category, transmits the identification result to the management port.

16. The system as claimed in claim 11, wherein the computing device transmits the identification result to the external management port using a Message Queuing Telemetry Transport (MQTT) protocol.

17. The system as claimed in claim 11, wherein the computing device defines the ROI to contain a fixed area of the displaying frame.

18. The system as claimed in claim 11, wherein the computing device identifies a pre-determined object from the displaying frame, and designates an area relative to the pre-determined object as the ROI.

19. The system as claimed in claim 11, wherein the computing device stores an image recognition container for enabling an image recognition functionality, and executes the image recognition container to obtain the ROI and to obtain the identification result for the ROI.

20. The system as claimed in claim 11, wherein the computing device stores a data transmission container for enabling a data transmission functionality, and executes the data transmission container to transmit the identification result to the management port.
